(19) United States
(12) Patent Application Publication
(10) Pub. No.: US 2019/0368671 A1
(43) Pub. Date: Dec. 5, 2019

(54) RECESSED MOUNT FOR LUMINAIRE

(71) Applicant: Lauren Illumination, LLC, New Philadelphia, OH (US)

(72) Inventors: Mitchell S. Pace, New Philadelphia, OH (US); Joshua Tyler Berkshire, New Philadelphia, OH (US); Wyatt Conner Angel, New Philadelphia, OH (US)

(21) Appl. No.: 15/997,320

(22) Filed: Jun. 4, 2018

(51) Int. Cl. F21S 8/02; F21V 21/04

(52) U.S. Cl. CPC F21S 8/026; F21Y 2115/10; F21V 21/049

(57) ABSTRACT

A mount allows an edge-lit, flat panel LED luminaire designed to be flush mounted to be recessed mounted with respect to a surface such as a ceiling. The recessed mount for an edge-lit, flat panel LED luminaire carries the luminaire at the top of a sidewall which defines an upper opening for the light emitting panel of the luminaire. Lateral supports retain the luminaire in alignment with the upper opening.

### CROSS REFERENCE TO RELATED APPLICATIONS

None.

### BACKGROUND OF THE DISCLOSURE

### 1. Technical Field

The disclosure relates to mounting devices for luminaires and, more particularly, to mounting devices for recess mounting a luminaire in a ceiling. Specifically, the disclosure relates to a luminaire mounting device that allows an edge-lit LED luminaire designed for flush mounting to be recessed mounted in a ceiling.

### 2. Background Information

Flush mounted luminaires designed to be mounted in ceilings are known in the art. Some of these luminaires are edge-lit light emitting diode (LED) luminaires which have a body recessed into a hole defined by a ceiling material but locate the light emitting panel substantially flush with the lower surface of the ceiling. An exemplary prior art edge-lit LED luminaire panel 10 is depicted in FIGS. 1-2 mounted in a hole defined by a ceiling 12. These luminaire panels are available in different diameters (four and six and eight inch being common examples) and shapes when viewed from below such square, rectangular, and the round example shown in FIGS. 1 and 2. These luminaires 10 generally include an outer flange 14 that abuts the lower surface of ceiling 12 when luminaire 10 is installed. Outer flange 14 defines an opening through which the light from luminaire 10 is dispersed. A light diffuser 16 is provided at this opening. Luminaire 10 generally includes a plurality of light emitting diodes directed to emit light directly into the edge or edges of a light guide plate and redirected downward through light diffuser 16. The light guide plate distributes essentially all of the light downward through light diffuser 16 which can include an optional glass or polymer cover. Luminaire 10 can also include cooling fins disposed above the LEDs and/or the light guide plate. Luminaire 10 also includes resilient locking arms 18 that engage the top surface of the ceiling to retain luminaire 10 in place at the opening defined by ceiling 12.

Some interior design applications use the flush mounted luminaires 10 as shown in FIGS. 1 and 2 with the light emitting surface of luminaire 10 being disposed substantially even with the lower surface of ceiling 12. Other interior design plans call for a different lighting configuration wherein the light-emitting surface of the luminaire is disposed above the ceiling with a sidewall or baffle extending up from the inner portion of the flange to define a recess that receives a light bulb or light emitting source. Traditional recessed can lighting functions in this manner.

### SUMMARY OF THE DISCLOSURE

The disclosure provides a mount that allows an edge-lit, flat panel LED luminaire designed to be flush mounted to be recessed mounted.

The disclosure provides a recessed mount for an edge-lit, flat panel LED luminaire wherein the luminaire is carried at the top of a sidewall which defines an upper opening for the light emitting panel of the luminaire. Lateral supports retain the luminaire in alignment with the upper opening.

The disclosure provides a recessed mount that allows the luminaire and the recessed mount to be installed from below the ceiling.

The recessed mount of the disclosure includes a body having a lower flange adapted to engage the lower surface of the ceiling. The lower flange has an inner edge that defines a lower opening. A sidewall extends up from the inner edge of the flange to define the height of the recess. The top of the sidewall defines an upper opening that is concentric with and smaller than the lower opening. The recessed mount includes resilient locking fingers that engage the upper surface of the ceiling to secure the recessed mount in place. The edge-lit, flat panel luminaire is carried at the top of the sidewall with the light emitting panel aligned with the upper opening. Lateral supports position the luminaire and retain its position with respect to the upper opening. The flange of the recessed mount has a larger overall diameter than the luminaire (or width dimension for square or rectangular configurations) to allow the assembly to be mounted from below the surface. The larger dimension allows the hole in the ceiling to be cut larger than the luminaire flange.

The preceding non-limiting aspects of the mount, as well as others, are more particularly described below. A more complete understanding of the mount can be obtained by reference to the accompanying drawings, which are not intended to indicate relative size and dimensions of the assemblies or components thereof. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF THE DRAWINGS

FIG. 1 is a plan view looking up at a ceiling with a prior art luminaire flush mounted.

FIG. 2 is a section view of the prior art luminaire taken along line 2-2 of FIG. 1.

FIG. 3 is a plan view looking up at a ceiling with the recessed mount of the disclosure mounting the luminaire from FIG. 1 in a recessed condition.

FIG. 4 is a section view of the recessed mount and luminaire taken along line 4-4 of FIG. 3.

FIG. 5 is a side view of the recessed mount and luminaire mounted in a ceiling panel.

FIG. 6 is a bottom perspective view of an exemplary configuration of the recessed mount carrying a luminaire.

FIG. 7 is a top perspective view of FIG. 6.

FIG. 8 is a front elevation view of FIG. 6.

FIG. 9 is a right side elevation view of FIG. 6.

FIG. 10 is a top plan view of FIG. 6.

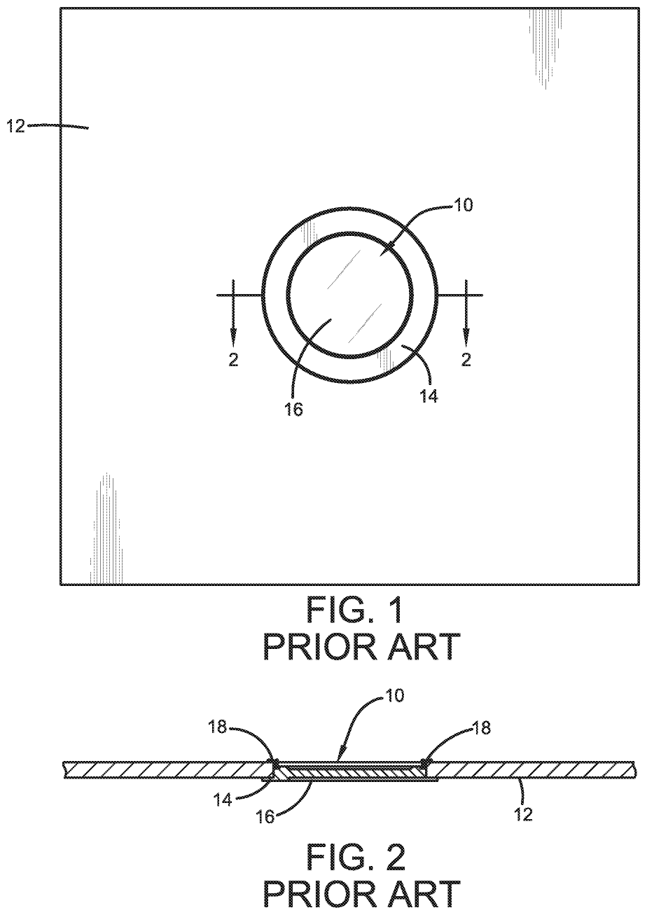

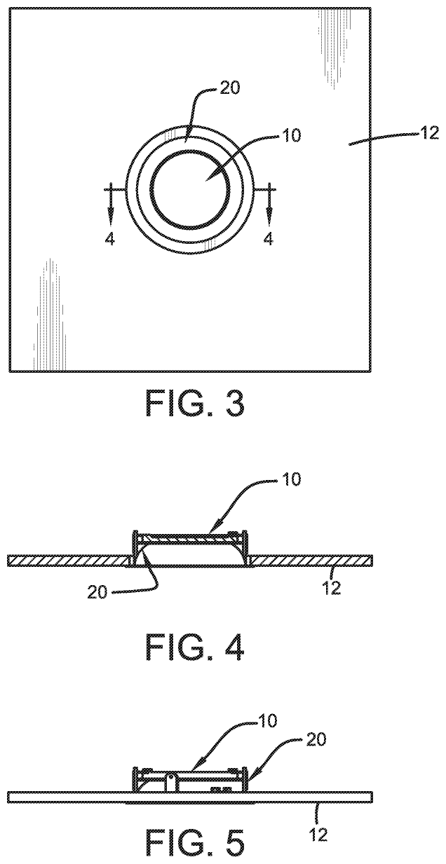

### DETAIL DESCRIPTION OF THE DISCLOSURE

The following detailed description illustrates by way of example, not by way of limitation, the principles of the invention. This description will clearly enable one skilled in the art to make and use the invention, and describes several embodiments, adaptations, variations, alternatives and uses of the invention. It should be understood that the drawings are diagrammatic and schematic representations of exemplary embodiments of the invention, and are not limiting of the present invention nor are they necessarily drawn to scale. Any dimensions are provided as examples.

An exemplary configuration for the recessed mount of the disclosure is indicated generally by the numeral 20 in the accompany drawings. Recessed mount 20 generally includes a flange 22 that has an outer edge 24 and an inner edge 26. Inner edge 26 defines a lower opening.

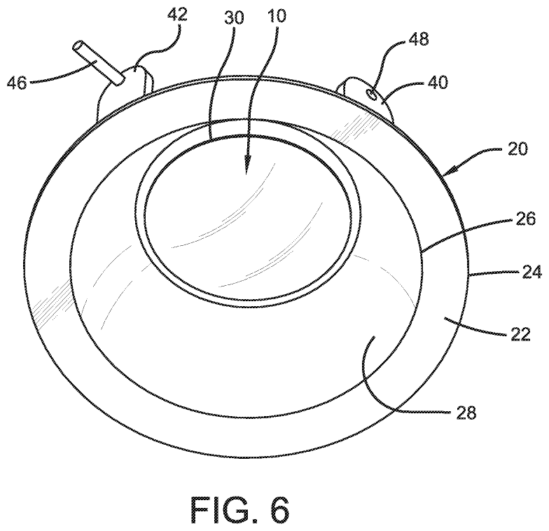

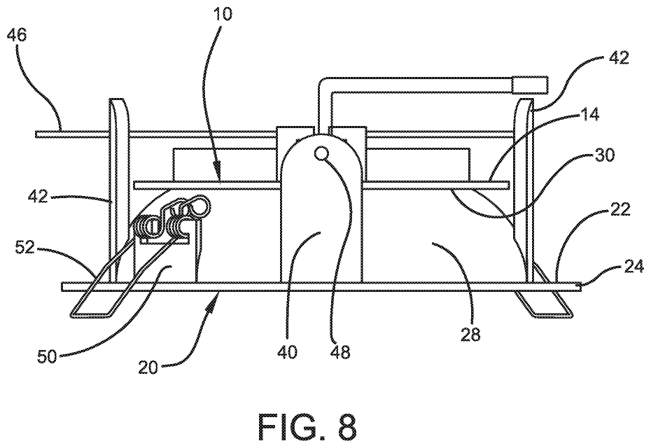

Recessed mount 20 also includes a sidewall 28 which extends upwardly from flange 22 to define the height of the recess for mount 20. Sidewall 28 has an upper end 30 which defines an upper opening. The upper opening is smaller than the lower opening. The upper opening can be concentric with the lower opening when viewed from directly below mount 20. When mount 20 is used with round luminaires 10, the lower and upper openings are round. When mount 20 is used with a square luminaire, the lower and upper openings are square. In other exemplary configurations, different shapes can be used and the shape of the lower opening is not required to match the shape of the upper opening. For example, the lower opening can be round with the upper opening being square. In both of these examples, sidewall 28 can match the shape of the openings or be provided in different shapes. In the exemplary configuration, sidewall 28 is a portion of a sphere or oval body cut with two parallel planes spaced apart by the height of sidewall 28. Sidewall 28 can be frusto-conical. Sidewall 28 can be a frustum of a pyramid when used with square openings. Upper opening is sized to be the same size as or slightly larger than the diffuser for luminaire 10 that is being carried by mount 20. As shown in the exemplary configuration in FIG. 6, sidewall 28 defines an optional flat ring radially outwardly of upper end 30. This flat ring provides a flat seat for luminaire 10 as shown in FIG. 8.

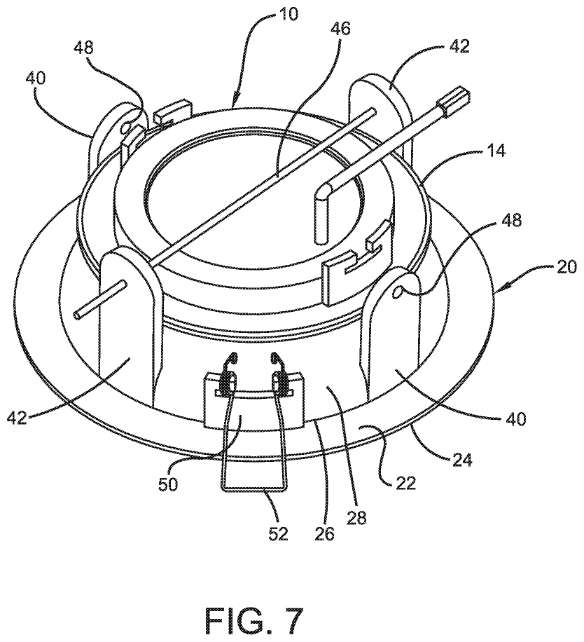

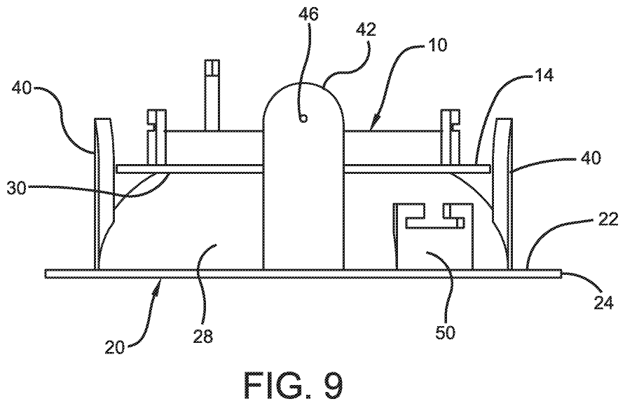

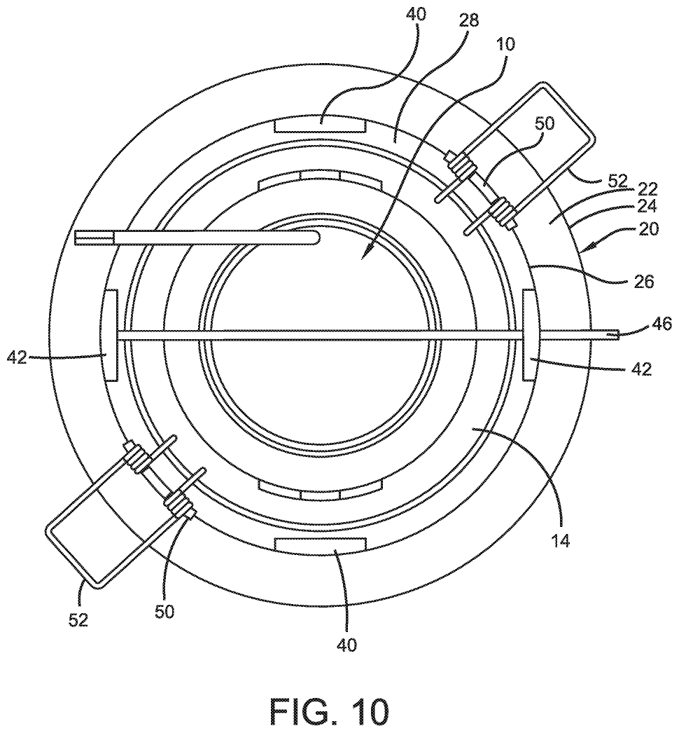

Recessed mount 20 also includes a plurality of lateral supports 40 and 42 that project upwardly from sidewall 28. Lateral supports 40 and 42 are disposed vertically when flange 22 is horizontal. Lateral supports 40 and 42 are disposed inwardly of inner edge 26 to allow them to fit through the hole in ceiling 12 where mount 20 is being installed. Such a hole has an opening size smaller than flange 22 but larger than the outer dimension of luminaire 10 so that luminaire 10 can be electrically connected to its power supply (with un-numbered cord depicted in FIGS. 7-10), placed on recessed mount 20, and then pushed up through the hole in the ceiling to its mounted position. In the exemplary configuration, lateral supports 40 and 42 are spaced apart at 90 degrees about sidewall 28. In other configurations, a single 360 degree lateral support ring can be used to retain luminaire 10. In other configurations, as few as two curved lateral supports can be used with each having a width and curvature sufficient to prevent luminaire 10 from moving laterally out from between them. Three or more lateral supports can be used. Each lateral support has an upper end disposed above the above upper end 30 of sidewall 28. These lateral supports 40 and 42 define the lateral boundaries for the luminaire seat disposed on top of sidewall 28. Supports 40 and 42 are positioned with respect to the upper opening to locate and align light emitting diffuser 16 of luminaire 10 with the upper opening defined by sidewall 28. The inner surfaces of lateral supports 40 and 42 laterally locate luminaire 10 and maintain its alignment with the upper opening. Supports 40 and 42 are spaced farther apart than the diameter or width of luminaire 10 so that luminaire does not have to be forced into place or frictionally slid down supports 40 and 42 to reach the seat. Small spaces between the outer edge of luminaire 10 and the inner surfaces of lateral supports 40 and 42 are provided to allow luminaire 10 to be seated without frictional or bending forces. The inner surfaces of lateral supports 40 and 42 can be curved to a radius slightly larger than the radius of flange 14. In another configuration, lateral supports 40 and 42 are configuration to provide a vertical retention force for luminaire 10. The vertical retention force can be frictional or supports 40 and 42 can be bent radially inwardly wherein they must be forced radially outwardly to allow luminaire 10 to be seated. The resiliency of the supports 40 and 42 provide the holding force after luminaire 10 is seated.

In the configuration of mount 20 depicted in the drawings, the vertical position of luminaire 10 can be maintained with gravity or a combination of gravity and friction between flange 14 and lateral supports 40 and 42. In the exemplary configuration, two of lateral supports 42 extend to a height above luminaire 10. A retaining wire 46 extends between lateral supports 42 to retain the vertical position of luminaire 10. Wire 46 can engage luminaire 10 or be disposed just above luminaire 10 to provide a stopping force is luminaire 10 moves upwardly with respect to mount 20.

One or more of lateral supports can include a hanger hole 48 that allows mount 20 to be secured to a ceiling joist by a hanger wire. The upper end of each lateral support is rounded to reduce any resistance in inserting mount 20 into the hole in the ceiling where mount 20 is being installed. The rounded ends also reduce the amount of material is used to mold mount 20.

Mount 20 includes a pair of holders 50 that carry resilient locking arms 52 that engage the upper surface of ceiling 12 to hold flange 22 and thus mount 20 in place. Each holder 50 can define the same shape slot as used by luminaire 10 so that the resilient locking fingers 18 of luminaire 10 can be repurposed as resilient locking arms 52.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the descriptions and illustrations of the exemplary configurations are examples and the invention is not limited to the exact details shown or described. Modifications and alterations of those embodiments will be apparent to one who reads and understands this general description. The present disclosure should be construed as including all such modifications and alterations insofar as they come within the scope of the appended claims or equivalents thereof. Throughout the description and claims of this specification the words “comprise” and “include” as well as variations of those words, such as “comprises,” “includes,” “comprising,” and “including” are not intended to exclude additives, components, integers, or steps.

1. A recessed mount for an edge-lit LED panel luminaire, the mount comprising:
a flange defining a lower opening;
a sidewall projecting up from flange and defining upper opening; the upper opening being smaller than the lower opening; the sidewall having an upper end defining a seat adapted to receive the luminaire; and
lateral supports projecting up from the sidewall above the upper end of the sidewall to define lateral boundaries of the seat adapted to receive the luminaire.

2. The mount of claim 1, wherein the upper and lower openings are circular.

3. The mount of claim 2, wherein the upper and lower openings are concentric.

4. The mount of claim 3, wherein the sidewall is curved between lower opening and upper opening.

5. The mount of claim 1, further comprising a pair of holders; a resilient locking arm connected to each of the holders.

6. The mount of claim 5, wherein each of the holders is connected to the sidewall; a portion of each resilient locking arm extending over the flange.

7. The mount of claim 1, further comprising a retaining device connected to two of the lateral supports.

8. The mount of claim 7, wherein the lateral supports that are connected to the retaining device have a height than is greater than other lateral supports.

9. The mount of claim 1, wherein at least one of the lateral supports defines an opening adapted to receive a hanger.

10. The mount of claim 1, wherein the lateral supports have rounded upper ends.

11. A recessed mount carrying an edge-lit LED panel luminaire, the assembly comprising:
a mount body having a flange, a sidewall, and a plurality of lateral supports;
an edge-lit LED panel luminaire carried by the mount body;
the flange defining a lower opening;
the sidewall projecting up from flange and defining an upper opening; the upper opening being smaller than the lower opening; the sidewall having an upper end defining a seat; the luminaire carried on the seat defined by the upper end of the sidewall; and
the lateral supports projecting up from sidewall above upper end of sidewall to define lateral boundaries of the seat for the luminaire; at least a portion of the luminaire being disposed directly between the lateral supports.

12. The assembly of claim 11, wherein the upper and lower openings are circular.

13. The assembly of claim 11, wherein the mount body includes a pair of holders; a resilient locking arm connected to each of the holders.

14. The assembly of claim 13, wherein each of the holders is connected to the sidewall;
a portion of each resilient locking arm extending over the flange of the mount body.

15. The assembly of claim 11, further comprising a retaining device connected to two of the lateral supports; a portion of the luminaire being disposed directly between the retaining device and the upper end of the sidewall.

16. The assembly of claim 15, wherein the lateral supports that are connected to the retaining device have a height than is greater than other lateral supports.

17. The assembly of claim 11, wherein at least one of the lateral supports defines an opening adapted to receive a hanger.

18. The assembly of claim 11, wherein the lateral supports have rounded upper ends.

19. A recessed mount for an edge-lit LED panel luminaire, the mount comprising:
a flange defining a circular lower opening;
a sidewall projecting up from flange and defining a circular upper opening; the upper opening being smaller than the lower opening;
the sidewall having an upper end defining a seat adapted to receive the luminaire;
a pair of holders connected to the sidewall;
a resilient locking arm connected to each of the holders;
lateral supports projecting up from sidewall above upper end of sidewall to define lateral boundaries of the seat for the luminaire; and
a retaining device connected to two of the lateral supports.

20. The mount of claim 19, wherein each of the lateral supports is disposed perpendicular to the flange.
